(19) United States
(12) Patent Application Publication
(10) Pub. No.: US 2006/0060223 A1
(43) Pub. Date: Mar. 23, 2006

(54) Dishwasher

(75) Inventors: Soung Bong Choi, Changwon-si (KR); Sang Heon Yoon, Seoul (KR); Nung Seo Park, Incheon (KR); Dae Yeong Han, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/061,738

(22) Filed: Feb. 22, 2005

(30) Foreign Application Priority Data
Sep. 17, 2004 (KR) P2004-74477

(51) Int. Cl. B08B 3/00

(52) U.S. Cl. 134/56 D; 134/104.2

(57) ABSTRACT

Dishwasher including a sump for holding washing water to wash dishes, and a sump cover having a washing water recovery portion for recovering the washing water, discharged for washing the dishes, to an inside of the sump, the sump cover covering an upper side of the sump, thereby permitting recovery of the washing water sprayed for washing dishes to the sump, smoothly.

### CROSS-REFERENCE TO RELATED APPLICATION

This application claims the benefit of Korean Application No. P2004-0074477 filed on Sep. 17, 2004, which is hereby incorporated by reference as if fully set forth herein.

### BACKGROUND OF THE INVENTION

1. Field of the Invention

The present invention relates to dishwashers, and more particularly, to a dishwasher which has an improved recovery efficiency of washing water.

2. Discussion of the Related Art

In general, the dishwasher washes dishes automatically. Since the dishwasher washes, rinses, dries, and stores the dishes, the dishwasher can reduce domestic work.

In washing methods of the dishwasher, there are a shower type, and a ultrasonic type, of which shower type is used widely in home. In the shower type, warm water having detergent dissolved therein is sprayed to the dishes on racks for washing. The water is sprayed by a propeller, or nozzles in a rotating pipe.

The dishwasher is provided with a cabinet, a door for opening/closing a front of the cabinet, a sump, and a pump. The cabinet forms an outer appearance of the dishwasher, and is provided with a tub therein for forming a washing space. Inside of the tub, there are racks for placing dishes thereon. The door is provided to the front of the cabinet for opening/closing the washing space.

Under the tub, there is a sump for holding the washing water. Provided to the sump, there is a washing pump for pumping the washing water from the sump. The washing pump has a motor coupled thereto for driving the pump.

The racks are an upper rack in an upper space of the tub, and a lower rack under the upper rack.

There are a top nozzle over the upper rack, and a lower nozzle under the lower rack. Between the upper rack and the lower rack, there is an upper nozzle. The nozzles are connected to the water guide, for spraying water to the dishes on the racks.

Above configuration enables the washing water, pumped by the pump, is guided by the water guide on one side of the tub, and sprayed to the dishes on the racks through the nozzles.

In the meantime, since it is required that the washing water sprayed from the nozzles is recovered to sump smoothly, recently development of a dishwasher is required, in which circulation of the washing water is made smoothly for improving the recovery efficiency of the washing water.

### SUMMARY OF THE INVENTION

Accordingly, the present invention is directed to a dishwasher that substantially obviates one or more problems due to limitations and disadvantages of the related art.

An object of the present invention is to provide a dishwasher of which washing water recovery efficiency is improved.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dishwasher includes a sump for holding washing water to wash dishes, and a sump cover having a washing water recovery portion for recovering the washing water, discharged for washing the dishes, to an inside of the sump, the sump cover covering an upper side of the sump.

The sump cover forms a bottom of the tub which provides a washing space, and the washing water on an upper surface of the sump cover flows toward the washing water recovery portion by gravity.

For an example, the upper surface of the sump cover is sloped downward toward the washing water recovery portion.

The washing water recovery portion is formed at a periphery of the sump cover.

The washing water recovery portion may include a plurality of recovery holes formed along at least one row of recovery hole line.

The dishwasher may further includes an inner housing between the sump and the sump cover, the inner housing having a contaminant holding portion formed therein for holding contaminant separated from pumped washing water.

The inner housing includes an upper housing having a first flow passage portion for guiding a portion of the pumped washing water to the contaminant holding portion, and a second flow passage portion for guiding rest of the pumped washing water to wash the dishes, and a lower housing having the contaminant holding portion, for seating the upper housing thereon.

The upper housing includes a sidewall projected upward from a circumference of a bottom of the upper housing at a predetermined height so as to be in close contact with an underside of the sump cover.

The lower housing further includes a upper housing seating portion for seating a bottom of the upper housing, and the contaminant holding portion is formed on an outer side of the upper housing seating portion.

Preferably, the sump cover further includes a discharge portion for discharging the washing water from the contaminant holding portion, and a filter member provided to the discharge portion for filtering contaminant from the washing water discharged form the contaminant holding portion.

According to this, the washing water discharged through the discharge portion passes the filter member, and recovered to an inside of the sump through the recovery portion.

The filter member includes at least one first filter having small holes, and at least one second filter having holes greater than the holes of the first filter.

The first filter and the second filter are formed as one body.

Preferably, the discharge portion includes a filter supporting portion for supporting at least one side of an upper side and a lower side of the filter member.

The filter supporting portion includes a plurality of supporting ribs arranged at regular intervals.

The filter supporting portion includes at least one lower supporting rib for supporting the lower side of the filter member, and at least one upper supporting rib for supporting the upper side of the filter member.

The upper supporting ribs and the lower supporting ribs are arranged opposite to each other, respectively.

The sump cover further includes a leakage preventing portion projected downward from an underside of the sump cover, for preventing the washing water from leaking between the inner housing and the sump cover.

The leakage preventing portion includes a first leakage preventing rib in close contact with the sidewall of the upper housing for preventing the washing water flowing through the first flow passage and the second flow passage from leaking, and a second leakage preventing rib in close contact with he sidewall of the lower housing for preventing the washing water from leaking from the contaminant holding chamber.

Preferably, the contaminant holding portion has a communication hole in a bottom thereof in communication with a drain pump for discharging the washing water, and the bottom of the contaminant holding portion is sloped downward toward the communication hole.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a longitudinal section of a dishwasher in accordance with a preferred embodiment of the present invention, schematically;

FIG. 2 illustrates an exploded perspective of a washing water holding unit in accordance with a preferred embodiment of the present invention in the dishwasher in FIG. 1;

FIG. 3 illustrates a longitudinal section across a line I-I in FIG. 2;

FIG. 4 illustrates a perspective view of an underside of the sump cover in accordance with a preferred embodiment of the present invention in the washing water holding unit in FIG. 2;

FIG. 5 illustrates a perspective view showing a state in which an upper housing in accordance with a preferred embodiment of the present invention is joined to an underside of the sump cover in FIG. 7;

FIG. 6 illustrates a partial longitudinal section of the filter supporting portion in accordance with a preferred embodiment of the present invention across a line II-II in FIG. 2;

FIG. 7 illustrates a partial longitudinal section of the filter supporting portion in a dishwasher in accordance with another preferred embodiment of the present invention; and

FIG. 8 illustrates a partial longitudinal section of the filter supporting portion in a dishwasher in accordance with another preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

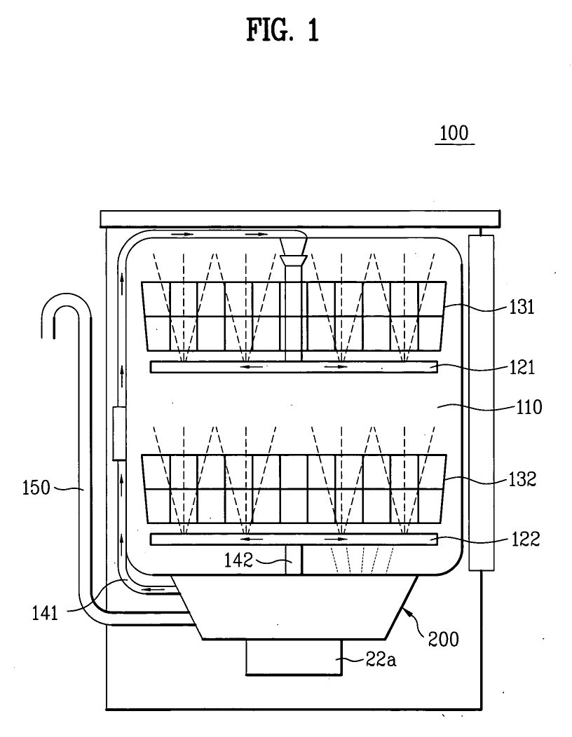

Referring to FIG. 1, the dishwasher 100 in accordance with a preferred embodiment of the present invention includes a tub 110 forming a space for washing the dishes, upper/lower spray arms 121, and 122 rotatably mounted in the tub 110, upper/lower racks 131, and 132 mounted over the upper/lower spray arms, and a washing water holding unit 200 for holding the washing water.

It is preferable that the washing water holding unit 200 has a driving unit for operating the dishwasher 100, and circulating the washing water. To an upper portion of the washing water holding unit 200, there are upper/lower connection pipes 141, and 142 for guiding the washing water to the upper/lower spray arms 121, and 122, and a drain hose 140 for draining contaminated washing water, connected thereto.

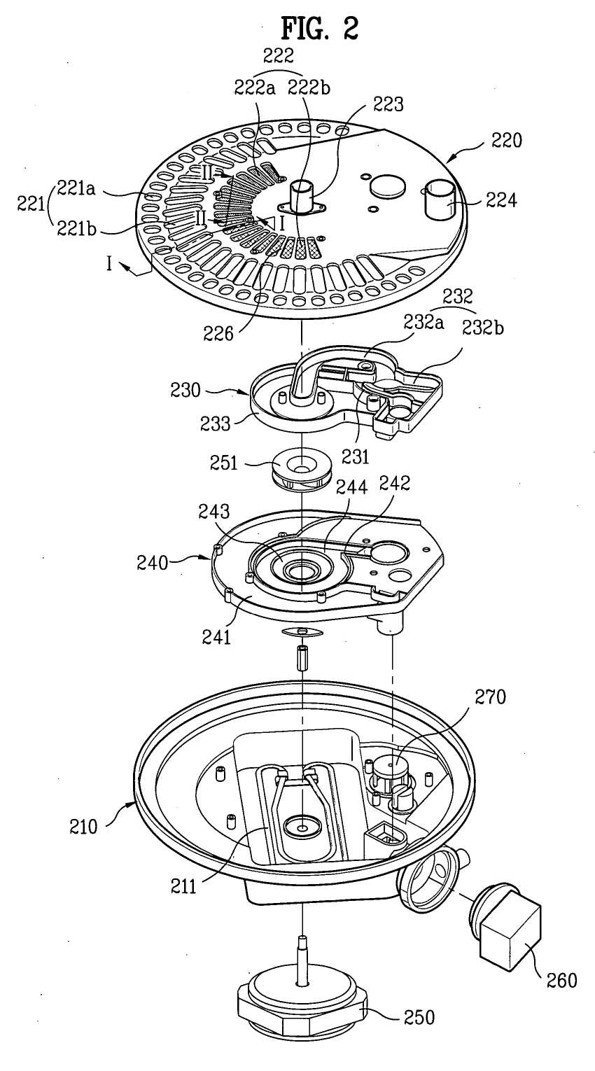

Referring to FIGS. 2-8, the washing water holding unit 200 will be described in more detail.

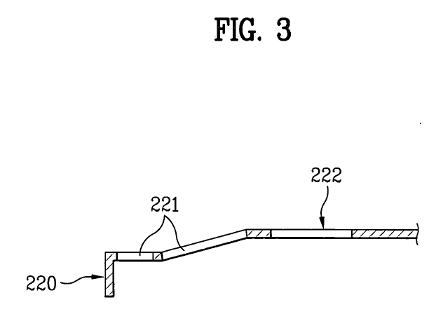

Referring to FIGS. 2 and 3, the washing water holding unit 200 includes a sump 210 at a lower portion of the tub 110 having an opened top for holding the washing water, and a sump cover 220 for covering an upper side of the sump 210. There is a heater 211 in the sump 210, for heating the washing water held in the sump 210 to a predetermined temperature to making dish washing easy.

The sump cover 220 has a washing water recovery portion 221 for recovering the washing water sprayed from the upper/lower spray arms 121, and 122 into the sump 210. In more detail, it is preferable that the sump cover 220 substantially has a disk shape which forms a bottom of the tub 110, and an upper surface configured to introduce the washing water sprayed from the upper/lower spray arms 121, and 122 and falling thereon into the washing water recovery portion 221.

For this, it is preferable that the upper surface of the sump cover 220 is sloped downwardly as the upper surface goes toward the washing water recovery portion 221. In more detail, the washing water recovery unit 221 is at a periphery of the sump cover 220. Accordingly, the sump cover 220 has a central portion formed more or less higher than the periphery of the sump cover 220. The washing water recovery portion 221 has a plurality of recovery holes formed along at least one row of the recovery hole line.

In the embodiment, though there are a first recovery hole line in a predetermined zone of the periphery in a circumferential direction, and a second recovery hole line on an inner side of the first recovery hole line in a circumferential direction, the configuration of the recovery holes is not limited to this. There are a plurality of first recovery holes 221a in the first recovery hole line, and a plurality of second recovery holes 221b in the second recovery hole line.

In the meantime, it is preferable that between the sump 210 and the sump cover 220, i.e., in a space formed by the sump 210 and the sump cover 220, there is an inner housing having a contaminant holding portion 241 formed therein. In more detail, the inner housing includes an upper housing 230, and a lower housing 240 joined to an underside of the upper housing 230.

The upper housing 230 includes a first flow passage portion 231 for guiding a portion of the pumped washing water to the contaminant holding portion 241, and a second flow passage portion 232 for guiding rest of the pumped washing water to the upper/lower connection pipes 141, and 142, and the upper housing 230 is seated on a bottom of the lower housing 240.

At a circumference of the bottom of the upper housing 230, there is a sidewall 233 projected upward from the bottom of the upper housing 230 to a predetermined height so as to be in close contact with the sump cover 220.

In the meantime, the contaminant holding portion 241 is formed in the lower housing 240 for holding contaminants separated from the pumped washing water. In more detail, there is an upper housing seating portion 242 at a substantially central portion of the lower housing 240 for seating a bottom of the upper housing, and the contaminant holding portion 241 is formed on an outer side of the upper housing seating portion 242.

In the upper housing seating portion 242, the bottom of the upper housing 230 is inserted.

In the meantime, the sump cover 220 has a discharge portion (not shown) for discharging washing water from the contaminant holding portion 241, and it is preferable that the discharge portion is provided with a filter member 222 for filtering contaminants from the washing water discharged from the contaminant holding portion 241.

It is preferable that the discharge portion is formed between the washing water recovery portion 221 and the center of the sump cover 220 substantially, in more detail, on the contaminant holding portion 241.

In addition to above configuration, it is preferable that, under the sump 210, there are a main motor 250 for providing power to the dishwasher, and a drain pump 260 at one side of the sump 210 for draining the washing water.

At a central portion of the lower housing 240, particularly, at a central portion of the upper housing seating portion 242, there is an impeller receiving portion 243 recessed downward coupled to the main motor 250, for receiving an impeller 251 to pump the washing water.

Around the impeller receiving portion 243, there is an introduction flow passage 244 for guiding the washing water from the impeller 251 to the flow passage portions 231, and 232. It is preferable that the impeller receiving portion 243 and the introduction flow passage 244 are stepped from each other.

The contaminant holding portion 241 is formed on an outer side of the upper housing seating portion 242 to have a predetermined depth, and it may be designed to discharge the contaminant from the contaminant holding portion 241 to an outside of the dishwasher when the washing water is discharged from the sump 210 by the drain pump 260.

To do this, it is preferable that, in one side of a bottom of the contaminant holding portion 241, there is a communication hole (not shown) in communication with the drain pump 260, and the bottom of the contaminant holding portion 241 is sloped downwardly toward the communication hole, for easy discharge of the contaminant from the contaminant holding portion 241 during a washing water discharge cycle of the dishwasher 100.

The contaminant holding portion 241 may, or may not be formed as one body with the impeller receiving portion 243.

It is preferable that the bottom of the lower housing 240, the bottom of the contaminant holding portion 241, and an underside of the impeller 251 are in a same plane substantially, for reducing a height of the washing water holding unit 200, increasing a washing space for washing dishes therein, and increasing a space for holding the washing water.

It is preferable that, in a bottom of the upper housing 230, there a communication hole (not shown) connected to the introduction flow passage 244 for introducing the washing water from the introduction flow passage 244 to the first flow passage portion 244 and the second flow passage portion 232 in a vertical direction, and on an underside of the upper housing 230 opposite to the impeller 251, there is an impeller cap (not shown) recessed upwardly for receiving an upper portion of the impeller 251.

The second flow passage portion 232 includes a lower main flow passage 232a for guiding the pumped washing water to the lower connection pipe 142, and an upper main flow passage 232b for guiding the pumped washing water to the upper connection pipe 141.

In the first flow passage portion 231, there may be a contamination level sensor (not shown) mounted therein for measuring a contamination level of the washing water introduced thereto through the first flow passage portion 231.

Moreover, in the upper housing, there is an opening for pass through of a flow passage control valve 270 to control a flow passage of the washing water in a vertical direction. The flow passage control valve 270 guides the pumped washing water to the upper main flow passage 232b and/or the lower main flow passage 232a.

At the central portion of the sump cover 220, there is a first connection portion 223 for connection to the lower connection pipe 142, and at a periphery of the sump cover 220, there is a second connection portion 224 for connection to the upper connection pipe 141.

In the meantime, it is preferable that there is a leakage preventing portion 225 on the sump cover 220 for preventing the washing water from leaking between the inner housing of the upper housing 230 and the lower housing 240 and the sump cover 220.

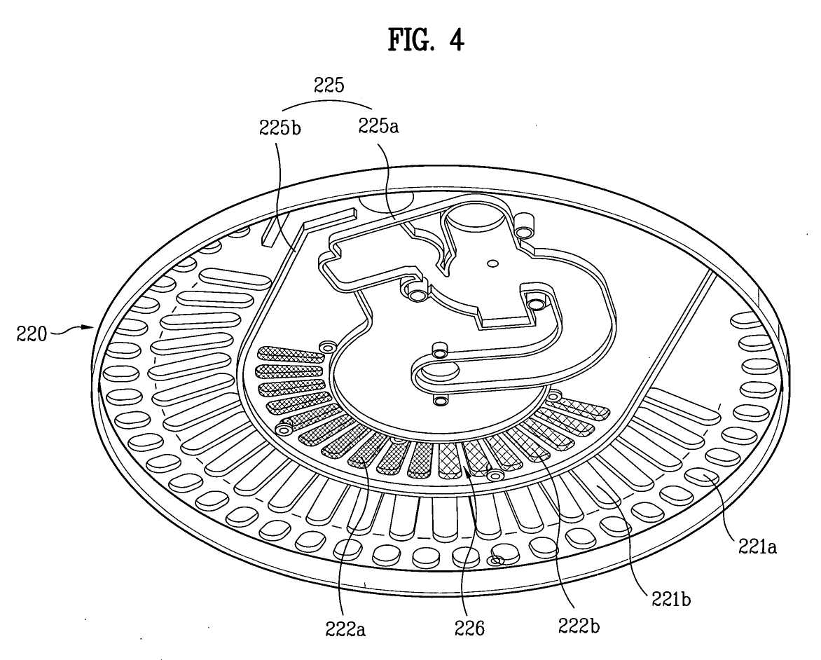

The leakage preventing portion 225 will be described, with reference to FIGS. 4 and 5.

The leakage preventing portion 225 includes a first leakage preventing rib 225a formed on the underside of the sump cover 300 at a portion thereof to be joined to the circumference of the upper housing 230, and a second leakage preventing rib 225b formed on the underside of the sump cover 300 at a portion thereof to be joined to the circumference of the lower housing 240.

The first leakage preventing rib 225a is in close contact with the sidewall of the upper housing 230, for preventing the washing water flowing along the first flow passage portion 231 and the second flow passage portion 232 from leaking. The second leakage preventing rib 225b prevents the washing water from leaking from the introduction flow passage 244 and the contaminant holding portion 241.

For this, each of the leakage preventing ribs 225a, or 225b is projected downward from the underside of the sump cover 220 at a predetermined height, for sealing an inside of the upper housing 230 as the first leakage preventing rib 330 encloses the sidewall of the upper housing 230 when the upper housing 230 is joined to the sump cover 220.

Though not shown, the second leakage preventing rib 225b also encloses the circumference, i.e., the sidewall of the lower housing 240, to seal the contaminant holding portion 241 inside of the lower housing.

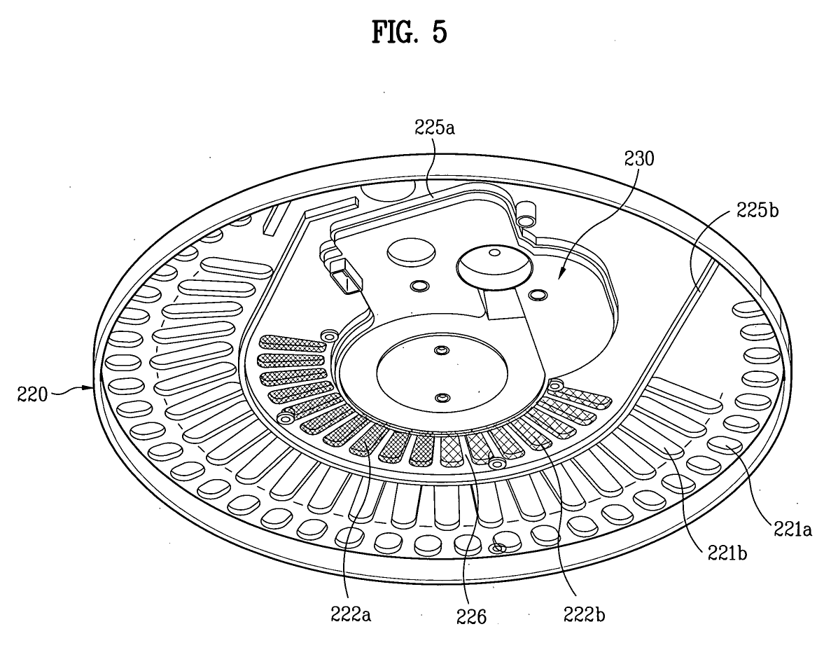

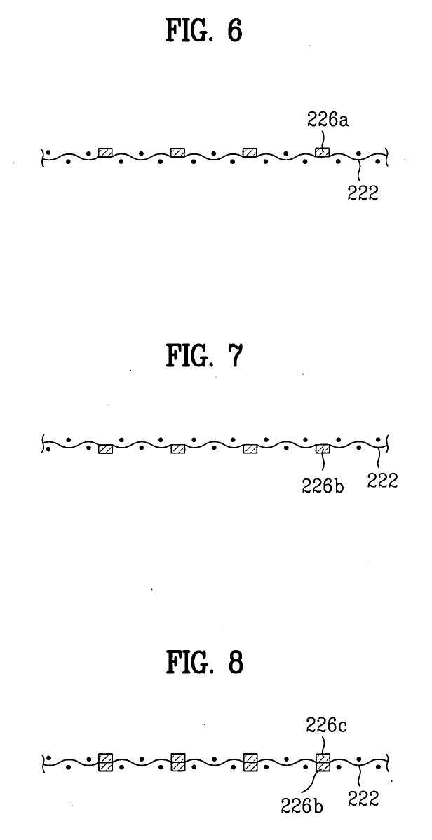

Referring to FIGS. 6 to 8, variations of the filter member 222 on the sump cover 220 will be described.

It is preferable that the filter member 222 includes a first filter 222a having a small hole size, and a second filter 222b having a hole size greater than the first filter 222a. In a case only the first filter 222a having smaller hole size is mounted on the sump cover 220, since a high water pressure acts on the first filter 222a, the first filter 222a is liable to deform, and when only the second filter 222b is mounted on the sump cover 220, the second filter 222b is liable to fail to filter fine contaminants.

Therefore, it is preferable that the first filter 222a having the small hole size is mounted on a portion of the discharge portion, and the second filter 222b having the great hole size is mounted on rest of the discharge portion. The first filter 222a and the second filter 222b may, or may not be formed as one body.

In addition to this, it is preferable that the discharge portion has a filter supporting portion 226 for supporting the filter member 222 to prevent the filters 222a, and 222b from sagging or deforming by the water pressure acted thereon as the washing water flows. For this, it is preferable that the filter supporting portion 226 supports at least one side of an upper side and a lower side of the filter member 222.

Referring to FIG. 3, a variation of the filter supporting portion 226 includes at least one upper supporting rib 226a for supporting an upper side of the filter member 222. It is preferable that a number of the upper supporting ribs 226a is determined appropriately according to an area of the filter member 222.

Next, referring to FIG. 7, another variation of the filter supporting portion 226 includes at least one lower supporting rib 226b for supporting a bottom of the filter member 222. It is also preferable that a number of the lower supporting ribs 226b is determined appropriately according to an area of the filter member 222.

However, if only the upper side of the filter member 222 is supported, the filter member 222 is liable to sag downward, or damaged as the washing water sprayed from the nozzle, and falling thereto hits the filter member 222. If only the bottom of the filter member 222 is supported, the filter member 222 is liable to deform upward by the water pressure of the washing water discharged from the contaminant holding portion 241.

Therefore, referring to FIG. 8, it is preferable that another variation of the filter supporting portion 226 includes at least one lower supporting rib 226b for supporting underside of the filter member 222, and at least one upper supporting rib 226a for supporting an upper side of the filter member 222. In this instance, the lower supporting rib 226b and the upper supporting rib 226a may be arranged opposite to each other to face each other, or alternately.

In each of above variations, it is preferable that, if the filter supporting portion 226 includes a plurality of supporting ribs, the plurality of supporting ribs are arranged at regular intervals.

The operation of the dishwasher of the present invention will be described.

Upon starting a washing cycle to drive the main motor 250, the impeller 251 rotates, to pump the washing water from the sump 210 to the upper housing 230. Then, from the upper housing 230, a portion of the washing water is introduced to the first flow passage portion 231, and rest of the washing water is introduced to the second flow passage portion 232.

The washing water introduced to the second flow passage portion 232 is guided to the upper connection portion 224 and/or the lower connection portion 223 by the flow passage control valve 270, and sprayed from the upper spray arm 121 and/or the lower spray arm 122, for washing the dishes.

The washing water, sprayed from the upper spray arm 121 and/or the lower spray arm 122, falls down onto the upper surface of the sump cover 220, flows to the washing water recovery portion 221 along the upper surface of the sump cover 220 sloped toward the washing water recovery portion 221 by the gravity, and recovered to the sump 210.

In the meantime, the washing water, flowing through the first flow passage portion 231, is introduced into the contaminant holding portion 241 in the lower housing 240. Then, the washing water has the contaminants filtered at the first filter 222a and the second filter 222b of the filter member, and is introduced into the washing water recovery portion 221 along the sloped upper surface of the sump cover 220, and recovered to the sump 210. In above steps, the supporting ribs 226a, and 226b which support the filters 222a, and 222b prevent the filters 222a, and 222b from deforming by the water pressure.

The washing water having washed the dishes, and the washing water passed through the filters 222a, and 222b is recovered to the sump 210 smoothly as the upper surface of the sump cover 220 is sloped downward toward the washing water recovery portion 221.

Next, upon finishing the washing cycle, the drain pump 260 is put into operation, to discharge the washing water from the sump 210 and table waste from the contaminant holding portion 241 to an outside of the dishwasher by a suction force of the drain pump 260.

As has been described, the dishwasher of the present invention has the following advantages.

First, the washing water recovery portion in the sump cover prevents shortage of the washing water, and improves a recovery efficiency of the washing water.

Second, the downward slope of the upper surface of the sump cover, which forms a bottom of the tub, toward the washing water recovery portion permits an easy recovery of the washing water.

Third, the filter supporting portion for preventing deformation of the filter member that separates foreign matter from the washing water prevents deformation or damage to the filter.

The improved water tightness between the sump cover and the inner housing enables smooth flow of the washing water.

Fifth, the slope of the bottom of the contaminant holding portion toward a direction of discharge of the washing water permits an easy discharge of the contaminant from the contaminant holding portion during a discharge cycle.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A dishwasher comprising:
a sump for holding washing water to wash dishes; and
a sump cover having a washing water recovery portion for recovering the washing water, discharged for washing the dishes, to an inside of the sump, the sump cover covering an upper side of the sump.

2. The dishwasher as claimed in claim 1, wherein the sump cover forms a bottom of the tub which provides a washing space, and the washing water on an upper surface of the sump cover flows toward the washing water recovery portion by gravity.

3. The dishwasher as claimed in claim 1, wherein the upper surface of the sump cover is sloped downward toward the washing water recovery portion.

4. The dishwasher as claimed in claim 3, wherein the washing water recovery portion is formed at a periphery of the sump cover.

5. The dishwasher as claimed in claim 4, wherein the washing water recovery portion includes a plurality of recovery holes formed along at least one row of recovery hole line.

6. The dishwasher as claimed in claim 1, further comprising an inner housing between the sump and the sump cover, the inner housing having a contaminant holding portion formed therein for holding contaminant separated from pumped washing water.

7. The dishwasher as claimed in claim 6, wherein the inner housing includes;
an upper housing having a first flow passage portion for guiding a portion of the pumped washing water to the contaminant holding portion, and a second flow passage portion for guiding rest of the pumped washing water to wash the dishes, and
a lower housing having the contaminant holding portion, for seating the upper housing thereon.

8. The dishwasher as claimed in claim 7, wherein the upper housing includes a sidewall projected upward from a circumference of a bottom of the upper housing at a predetermined height so as to be in close contact with an underside of the sump cover.

9. The dishwasher as claimed in claim 7, wherein the lower housing further includes a upper housing seating portion for seating a bottom of the upper housing, and the contaminant holding portion is formed on an outer side of the upper housing seating portion.

10. The dishwasher as claimed in claim 9, wherein the sump cover further includes;
a discharge portion for discharging the washing water from the contaminant holding portion, and
a filter member provided to the discharge portion for filtering contaminant from the washing water discharged form the contaminant holding portion.

11. The dishwasher as claimed in claim 10, wherein the washing water discharged through the discharge portion passes the filter member, and recovered to an inside of the sump through the recovery portion.

12. The dishwasher as claimed in claim 10, wherein the filter member includes;
at least one first filter having small holes, and
at least one second, filter having holes greater than the holes of the first filter.

13. The dishwasher as claimed in claim 12, wherein the first filter and the second filter are formed as one body.

14. The dishwasher as claimed in claim 10, wherein the discharge portion includes a filter supporting portion for supporting at least one side of an upper side and a lower side of the filter member.

15. The dishwasher as claimed in claim 14, wherein the filter supporting portion includes a plurality of supporting ribs arranged at regular intervals.

16. The dishwasher as claimed in claim 14, wherein the filter supporting portion includes;
at least one lower supporting rib for supporting the lower side of the filter member, and
at least one upper supporting rib for supporting the upper side of the filter member.

17. The dishwasher as claimed in claim 14, wherein the upper supporting ribs and the lower supporting ribs are arranged opposite to each other, respectively.

18. The dishwasher as claimed in claim 7, wherein the sump cover further includes a leakage preventing portion projected downward from an underside of the sump cover, for preventing the washing water from leaking between the inner housing and the sump cover.

19. The dishwasher as claimed in claim 18, wherein the leakage preventing portion includes;
a first leakage preventing rib in close contact with the sidewall of the upper housing for preventing the washing water flowing through the first flow passage and the second flow passage from leaking, and
a second leakage preventing rib in close contact with he sidewall of the lower housing for preventing the washing water from leaking from the contaminant holding chamber.

20. The dishwasher as claimed in claim 6, wherein the contaminant holding portion has a communication hole in a bottom thereof in communication with a drain pump for discharging the washing water, and the bottom of the contaminant holding portion is sloped downward toward the communication hole.
